(19) United States
(12) Patent Application Publication
(10) Pub. No.: US 2011/0041937 A1
(43) Pub. Date: Feb. 24, 2011

(54) Faucet Device Background of the invention

(76) Inventor: Yu Chiu Yang, Changhua Hsien (TW)

Correspondence Address: CHARLES E. BAXLEY, ESQUIRE, 90 JOHN STREET, SUITE 403, NEW YORK, NY, 10038, US

(21) Appl. No.: 12/583,563

(22) Filed: Aug. 21, 2009

(51) Int. Cl. F16K 11/22

(52) U.S. Cl. 137/606; 137/801

(57) ABSTRACT

A faucet device includes two tubes each having a lower portion for receiving a cold water and a hot water, a connector pipe coupled between the tubes for forming a solid H-shaped structure, and a mixing pipe attached to the connector pipe for mixing the cold water and the hot water, two valve assemblies attached to the upper portions of the tubes for controlling the water from the tubes to the connector pipe, and a spout attached to the mixing pipe, the mixing pipe and the connector pipe and the tubes are solidly secured together and may be easily and quickly assembled to a washbasin by the users themselves.

### BACKGROUND OF THE INVENTION

1. Field of the Invention

The present invention relates to a faucet device, and more particularly to a faucet device including an improved and simplified structure for allowing the faucet device to be easily and quickly made or manufactured and to be easily and quickly assembled by the users themselves.

2. Description of the Prior Art

Typical faucet devices or assemblies comprise a spout, and two valve devices coupled to the spout with a central shank and a number of o-ring seals and a number of lock nuts or fasteners or lock rings.

For example, U.S. Pat. No. Re. 30,559 which is a reissue of U.S. Pat. No. 4,064,900 to Schmitt discloses one of the typical non-rise faucet assemblies having a rotatable, non-rise stem and which stem can be axially removed from its shank, and a removable retainer clip which slides into a transverse slot in the shank and forces the stem into proper seating engagement with the stem and locks the stem in place.

However, the typical non-rise faucet assembly includes a number of parts or elements and includes a complicated structure having a central shank and a number of o-ring seals and a number of lock nuts or fasteners or lock rings required to be provided and coupled between a spout and two valve devices for mixing cold and hot water, and the number of parts or elements may not be easily and quickly assembled by the users themselves.

U.S. Pat. No. 6,085,784 to Bloom et al. discloses another typical quick connect hose assembly comprising a T-connector and a number of connectors for connecting or coupling a spout and two valve devices together, in which the valve devices are required to be coupled to the cold water reservoir and the hot water reservoir respectively.

However, similarly, the typical quick connect hose assembly includes a complicated structure and includes a number of parts or elements that may not be easily and quickly assembled by the users themselves.

The present invention has arisen to mitigate and/or obviate the afore-described disadvantages of the conventional faucet devices or assemblies.

### SUMMARY OF THE INVENTION

The primary objective of the present invention is to provide a faucet device including an improved and simplified structure for allowing the faucet device to be easily and quickly made or manufactured and to be easily and quickly assembled by the users themselves.

In accordance with one aspect of the invention, there is provided a faucet device comprising a connector assembly including two tubes spaced from each other, and the tubes each including a lower portion for receiving a cold water and a hot water respectively and each including an upper portion, a connector pipe disposed and coupled between the tubes and solidly secured to the tubes for forming an H-shaped structure, and a mixing pipe attached and mounted to the connector pipe for receiving the cold water and the hot water from the tubes respectively and for allowing the cold water and the hot water to be mixed within the mixing pipe, two valve assemblies attached to the upper portions of the tubes respectively for controlling the cold water and the hot water to flow from the tubes to the connector pipe respectively, and a spout attached and mounted to the mixing pipe for allowing the mixed water to flow from the mixing pipe through the spout, the central or middle mixing pipe and the connector pipe and the tubes are solidly welded or secured or mounted together such that the users may easily and quickly assemble the upper portions of the tubes and the valve assemblies to a washbasin, and the spout may also be easily and quickly assembled to the central or middle mixing pipe by the users themselves.

The valve assemblies each include a handle for controlling the cold water and the hot water to flow from the tubes to the connector pipe respectively.

The spout includes a control valve device attached and mounted to the mixing pipe for controlling the mixed water to flow from the mixing pipe to the spout.

The tubes are preferably parallel to each other. The connector pipe is preferably perpendicular to the tubes. The mixing pipe is preferably perpendicular to the connector pipe and parallel to the tubes.

The upper portions of the tubes are preferably the threaded upper portion for coupling to the valve assemblies respectively. The lower portions of the tubes are preferably the threaded lower portion for threading or attaching or mounting or coupling to a cold water reservoir and a hot water reservoir respectively, and the connector assembly is preferably made of copper material or the copper alloy material.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a faucet device in accordance with the present invention;

FIG. 2 is a partial cross sectional view of the faucet device, illustrating the operation of the faucet device; and

FIG. 3 is another partial exploded view illustrating the other arrangement of the faucet device.

### DETAILED DESCRIPTION OF THE PREFERRED EMBODIMENT

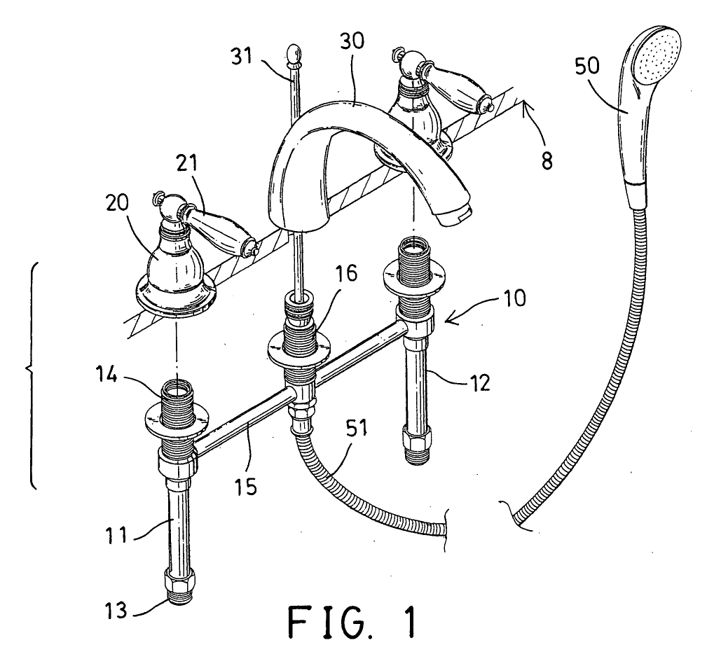

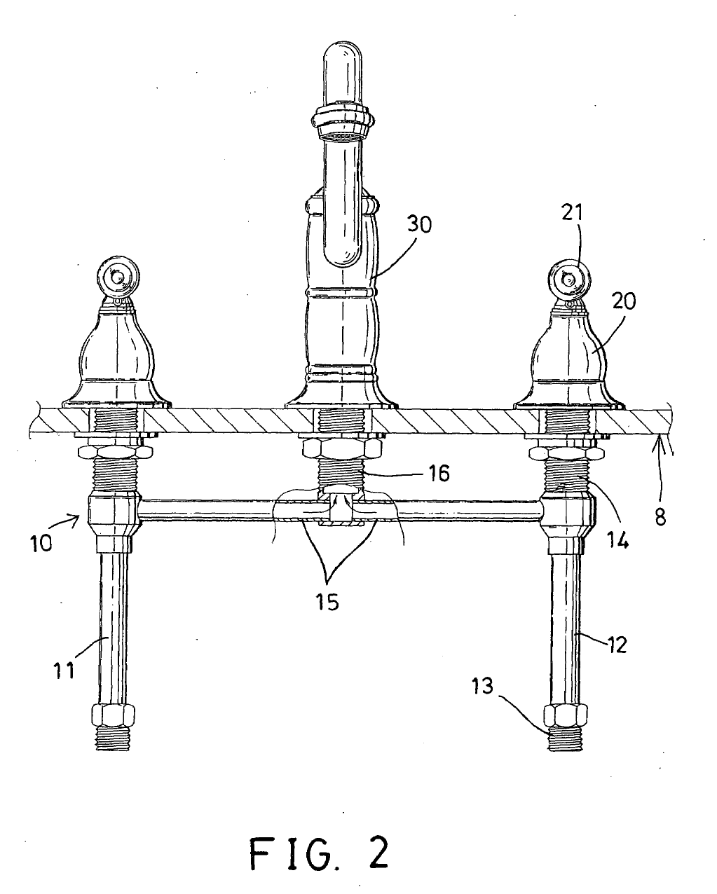

Referring to the drawings, and initially to FIGS. 1 and 2, a faucet device in accordance with the present invention comprises a connector assembly 10 made of copper material and/or the alloy thereof, and including two hard or solid or straight tubes 11, 12 disposed up and down or vertically and spaced from each other and parallel to each other, and the tubes 11, 12 each include a lower portion 13, such as a threaded lower portion 13 for coupling to a water reservoir, such as a cold water reservoir and a hot water reservoir respectively (not shown) for receiving the cold water and the hot water from the cold water reservoir and the hot water reservoir respectively, and each include an upper portion 14, such as a threaded upper portion 14 threaded or coupled to a valve assemblies 20 which includes a handle 21 attached thereto for controlling the water to flow into or through the tubes 11, 12 respectively.

The connector assembly 10 further includes a hard or solid or straight connector pipe 15 laterally disposed or coupled between the tubes 11, 12 and solidly welded or secured or mounted to the tubes 11, 12 and arranged perpendicular to the tubes 11, 12 for forming a substantially solid H-shaped structure, and a central or middle hard or solid or straight mixing pipe 16 attached or mounted to the central or middle of the connector pipe 15 and disposed or arranged perpendicular to the connector pipe 15 and parallel to the tubes 11, 12 for receiving the cold water and the hot water from the tubes 11, 12 respectively and for allowing the cold water and the hot water to be mixed or blended or combined within the central or middle mixing pipe 16. The valve assemblies 20 are provided for controlling the water to flow from the tubes 11, 12 to the connector pipe 15 respectively.

In operation, the upper portions 14 of the tubes 11, 12 and the valve assemblies 20 may be attached or mounted to a washbasin 8, a washbowl, a bathtub, or the like. The faucet device in accordance with the present invention further comprises a spout 30 attached or mounted to the central or middle mixing pipe 16 and disposed or arranged for allowing the mixed water to flow from the central or middle mixing pipe 16 through the spout 30, and a control valve device 31 may further be provided and attached or mounted or coupled to the central or middle mixing pipe 16 for controlling the water to flow from the connector pipe 15 to the central or middle mixing pipe 16 and the spout 30, or from the central or middle mixing pipe 16 to the spout 30.

The faucet device in accordance with the present invention further comprises a sprayer device 50 coupled to the connector pipe 15 and/or the central or middle mixing pipe 16 with a connector hose 51 for allowing the mixed water to selectively flow out through the sprayer device 50, and the control valve device 31 may be provided or used to control the water to flow through either the spout 30 or the sprayer device 50. It is to be noted that the central or middle mixing pipe 16 and the connector pipe 15 and the tubes 11, 12 are solidly welded or secured or mounted together such that the users may easily and quickly assemble the upper portions 14 of the tubes 11, 12 and the valve assemblies 20 to the washbasin 8, and the spout 30 may also be easily and quickly assembled to the central or middle mixing pipe 16.

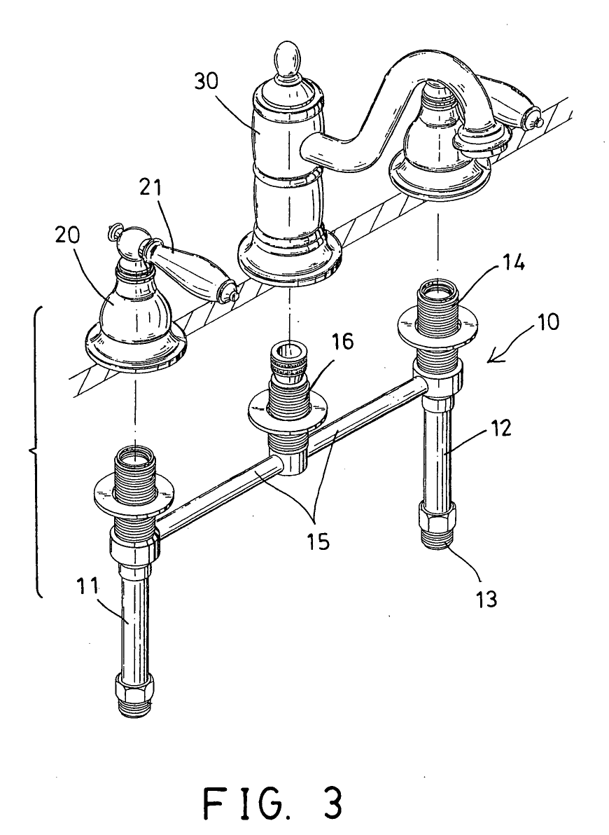

Alternatively, as shown in FIG. 3, the sprayer device 50 and the connector hose 51 may also be detached or disengaged from the connector pipe 15 and/or the central or middle mixing pipe 16, and the central or middle mixing pipe 16 and the connector pipe 15 and the tubes 11, 12 may also be easily and quickly assembled to the washbasin 8 and the spout 30 and the valve assemblies 20 by the users themselves.

Accordingly, the faucet device in accordance with the present invention includes an improved and simplified structure for allowing the faucet device to be easily and quickly made or manufactured and to be easily and quickly assembled by the users themselves.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A faucet device comprising:
a connector assembly including two tubes spaced from each other, and said tubes each including a lower portion for receiving a cold water and a hot water respectively and each including an upper portion, a connector pipe disposed and coupled between said tubes and solidly secured to said tubes for forming an H-shaped structure, and a mixing pipe attached and mounted to said connector pipe for receiving the cold water and the hot water from said tubes respectively and for allowing the cold water and the hot water to be mixed within said mixing pipe,
two valve assemblies attached to said upper portions of said tubes respectively for controlling the cold water and the hot water to flow from said tubes to said connector pipe respectively, and
a spout attached and mounted to said mixing pipe for allowing the mixed water to flow from said mixing pipe through said spout.

2. The faucet device as claimed in claim 1, wherein said valve assemblies each include a handle for controlling the cold water and the hot water to flow from said tubes to said connector pipe respectively.

3. The faucet device as claimed in claim 1, wherein said spout includes a control valve device attached and mounted to said mixing pipe for controlling the mixed water to flow from said mixing pipe to said spout.

4. The faucet device as claimed in claim 1, wherein said tubes are parallel to each other.

5. The faucet device as claimed in claim 1, wherein said connector pipe is perpendicular to said tubes.

6. The faucet device as claimed in claim 1, wherein said mixing pipe is perpendicular to said connector pipe and parallel to said tubes.

7. The faucet device as claimed in claim 1, wherein said upper portions of said tubes are threaded upper portion for coupling to said valve assemblies respectively.

8. The faucet device as claimed in claim 1, wherein said lower portions of said tubes are threaded lower portion.

9. The faucet device as claimed in claim 1, wherein said connector assembly is made of copper material.
